(19) United States
(12) Patent Application Publication
(10) Pub. No.: US 2020/0287452 A1
(43) Pub. Date: Sep. 10, 2020

(54) MOTOR COIL SUBSTRATE AND MOTOR

(71) Applicant: IBIDEN CO., LTD., Ogaki (JP)

(72) Inventors: Haruhiko MORITA, Ogaki (JP); Hitoshi MIWA, Ogaki (JP); Shinobu KATO, Ogaki (JP); Toshihiko YOKOMAKU, Ibi-gun (JP); Hisashi KATO, Ogaki (JP); Takahisa HIRASAWA, Ogaki (JP); Tetsuya MURAKI, Ogaki (JP); Takayuki FURUNO, Ogaki (JP)

(73) Assignee: IBIDEN CO., LTD., Ogaki (JP)

(21) Appl. No.: 16/804,026

(22) Filed: Feb. 28, 2020

(30) Foreign Application Priority Data
Mar. 4, 2019 (JP) 2019-038461

(51) Int. Cl. H02K 23/30; H02K 3/26; H02K 3/28

(52) U.S. Cl. CPC H02K 23/30; H02K 2203/03; H02K 3/28; H02K 3/26

(57) ABSTRACT

A motor coil substrate includes a coil substrate including a flexible substrate and multiple coils formed on the flexible substrate such that the coils are extending from a first end toward a second end on the opposite side with respect to the first end. The flexible substrate includes inner peripheral and outer peripheral flexible substrates such that the coils include outer peripheral coils formed on the outer peripheral flexible substrate and inner peripheral coils formed on the inner peripheral flexible substrate, that a number of the outer peripheral coils and a number of the inner peripheral coils are L, that an m-th outer peripheral coil of the outer peripheral coils is positioned on a m-th inner peripheral coil of the inner peripheral coils, and that the m-th outer peripheral coil and the m-th inner peripheral coil are connected to each other in parallel, where L and m are natural numbers.

### CROSS-REFERENCE TO RELATED APPLICATIONS

The present application is based upon and claims the benefit of priority to Japanese Patent Application No. 2019-038461, filed Mar. 4, 2019, the entire contents of which are incorporated herein by reference.

### BACKGROUND OF THE INVENTION

### Field of the Invention

The present invention relates to a motor coil substrate and a motor.

### Description of Background Art

Japanese Patent Application Laid-Open Publication No. 2007-124892 relates to an electric motor, which includes multiple single coils formed of wires. The entire contents of this publication are incorporated herein by reference.

### SUMMARY OF THE INVENTION

According to one aspect of the present invention, a motor coil substrate includes a coil substrate including a flexible substrate and multiple coils formed on the flexible substrate such that the coils are extending from a first end of the flexible substrate toward a second end of the flexible substrate on the opposite side with respect to the first end. The flexible substrate includes an inner peripheral flexible substrate and an outer peripheral flexible substrate extending from the inner peripheral flexible substrate and wound around the inner peripheral flexible substrate such that the coils include outer peripheral coils formed on the outer peripheral flexible substrate and inner peripheral coils formed on the inner peripheral flexible substrate, that a number of the outer peripheral coils and a number of the inner peripheral coils are L, that an m-th outer peripheral coil of the outer peripheral coils is positioned on a m-th inner peripheral coil of the inner peripheral coils, and that the m-th outer peripheral coil and the m-th inner peripheral coil are connected to each other in parallel, where L and m are natural numbers.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1A is a schematic diagram of a motor;

FIG. 1B is a schematic diagram of a motor coil substrate;

FIG. 1C illustrates upper coils of a coil substrate of a first embodiment;

FIG. 2A illustrates a cross section of a motor coil substrate of an embodiment;

FIG. 2B is a circuit diagram of the first embodiment;

FIG. 2C is a circuit diagram of a second embodiment;

FIG. 3A illustrates upper coils of a coil substrate of the second embodiment; and

FIG. 3B illustrates lower coils of the coil substrate.

### DETAILED DESCRIPTION OF THE EMBODIMENTS

Embodiments will now be described with reference to the accompanying drawings, wherein like reference numerals designate corresponding or identical elements throughout the various drawings.

### First Embodiment

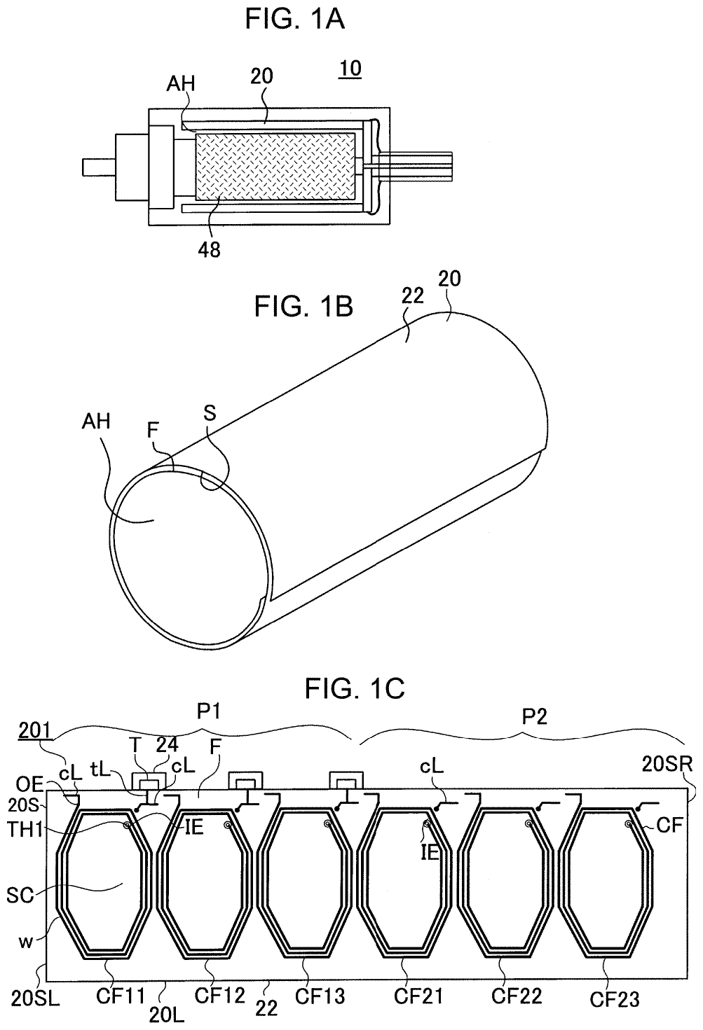

A coil substrate 201 illustrated in FIG. 1C is prepared. The coil substrate 201 is formed of a flexible substrate 22 and upper coils (CF), the flexible substrate 22 having a first surface (F) and a second surface (S) on an opposite side with respect to the first surface (F), and the upper coils (CF) being formed on the first surface (F) of the flexible substrate 22. By winding the coil substrate 201 in a tubular shape, a motor coil substrate 20 illustrated in FIG. 1B is obtained. The motor coil substrate 20 is wound around a hollow space (AH). For example, the motor coil substrate 20 has a tubular shape. The number of windings is 2 or more and 5 or less. FIG. 1B is a schematic diagram.

As illustrated in FIG. 1A, a motor 10 is obtained by arranging a magnet 48 inside the motor coil substrate 20. FIG. 1A is a schematic diagram. The motor coil substrate 20 is arranged around the magnet 48 via a hollow space (AH). An example of the motor 10 is a DC motor. The motor 10 can further have a commutator, a brush and a housing (which are not illustrated in the drawings). In the first embodiment, the motor coil substrate 20 rotates. However, it is also possible that the magnet 48 rotates.

As illustrated in FIG. 1C, the flexible substrate 22 preferably has short sides (20S) and long sides (20L). The upper coils (CF) are arranged along the long sides (20L) of the flexible substrate 22. The upper coils (CF) are arranged in one row from one end (20SL) to the other end (20SR) of the flexible substrate 22. The number of the upper coils (CF) is N (number (N)). In the example in FIG. 1C, the number of the upper coils is 6.

The number (N) of the upper coils (CF) satisfies the following Relation 1.

N=K×L, Relation 1:

wherein K and L are natural numbers. For example, K is 2 or more. For example, L is 3 or more and 11 or less.

The coil substrate 201 is formed of the single-piece flexible substrate 22. The flexible substrate 22 forming the coil substrate 201 is divided into multiple portions. Therefore, the coil substrate 201 is also divided into multiple portions. The coil substrate 201 is formed of multiple portions, and the number of the portions is K. The portions forming the coil substrate 201 are arranged from the one-end (20SL) to the other-end (20SR). The first portion includes the one-end (20SL) of the flexible substrate 22. The second portion is next to the first portion. The third portion is next to the second portion. And, the K-th portion includes the other-end (20SR) of the flexible substrate 22. That is, the (j+1)-th portion is arranged next to the j-th portion. The number of upper coils in the j-th portion and the number of upper coils in the (j+1)-th portion are equal to each other. j is a natural number. j is less than or equal to K. j is preferably 2 or more. For example, K is the number of windings of the flexible substrate 22.

The portions forming the coil substrate 201 each have multiple upper coils (CF), and the number of the upper coils formed in each of the portions is L. L is preferably an odd number. In each of the portions, the upper coils (CF) are sequentially arranged. In each of the portions, the first upper coil is closest to the one-end (20SL) of the flexible substrate 22. In each of the portions, the second upper coil is next to the first upper coil. In each of the portions, the third upper coil is next to the second upper coil. In each of the portions, the L-th upper coil is closest to the other-end (20SR) of the flexible substrate 22. That is, in each of the portions, the (m+1)-th upper coil (CF) is formed next to the m-th upper coil (CF). m is a natural number. The number of the coils (C) formed in each of the portions (P) is, for example, 3 or more and 11 or less.

In the first embodiment, the m-th upper coils are connected to each other in parallel. The m-th upper coil in the j-th portion and the m-th upper coil in the (j+1)-th portion are connected to each other in parallel. That is, the first upper coils are connected to each other in parallel. The second upper coils are connected to each other in parallel. The L-th upper coils are connected to each other in parallel. Then, the m-th upper coils connected to each other in parallel form an m-th parallel coil. The (m+1)-th upper coils connected to each other in parallel form an (m+1)-th parallel coil. Then, the m-th parallel coil is connected in series to the (m+1)-th parallel coil. That is, the first parallel upper coil is connected in series to the second parallel upper coil. The second parallel upper coil is connected in series to the third parallel upper coil. The (L−1)-th parallel upper coil is connected in series to the L-th parallel upper coil. m is a natural number.

Since the coils in the different portions are connected to each other in parallel, the multiple coils can be connected to each other with low resistance. A large current can be applied to the coils.

In the example of FIG. 1C, K is 2. That is, the number of the portions (P) is 2. The coil substrate 201 of FIG. 1C is formed of a first portion (P1) and a second portion (P2).

Further, L is 3. That is, the number of the upper coils (CF) in each of the portions (P) forming the coil substrate 201 of FIG. 1C is 3. A first upper coil (CF11), a second upper coil (CF12), and a third upper coil (CF13) are arranged in the first portion (P1). A first upper coil (CF21), a second upper coil (CF22), and a third upper coil (CF23) are arranged in the second portion (P2).

Then, the first upper coil (CF11) in the first portion (P1) and the first upper coil (CF21) in the second portion (P2) are connected to each other in parallel.

The second upper coil (CF12) in the first portion (P1) and the second upper coil (CF22) in the second portion (P2) are connected to each other in parallel.

The third upper coil (CF13) in the first portion (P1) and the third upper coil (CF23) in the second portion (P2) are connected to each other in parallel.

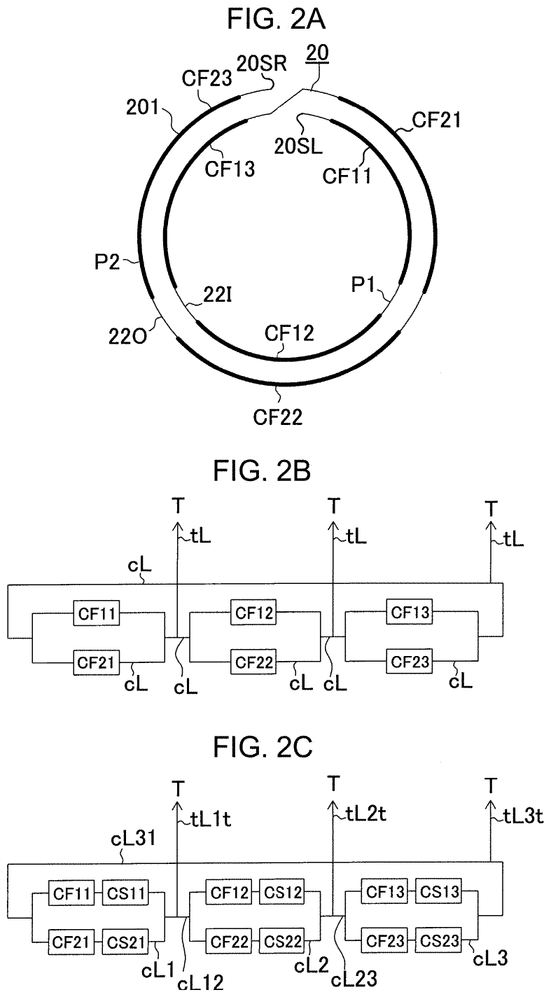

FIG. 2B illustrates an example of a circuit diagram of the first embodiment. As illustrated in FIG. 2B, the multiple first upper coils (CF11, CF21) (which are connected to each other in parallel) are connected in series to the multiple second upper coils (CF12, CF22) (which are connected to each other in parallel), the multiple second upper coils (CF12, CF22) are connected in series to the multiple third upper coils (CF13, CF23) (which are connected to each other in parallel), and the multiple third upper coils (CF13, CF23) are connected in series to the multiple first upper coils (CF11, CF21).

The multiple coils (C) formed on the flexible substrate 22 are simultaneously formed. For example, the multiple coils (C) are formed on the flexible substrate 22 using an alignment mark. Therefore, positions of the coils (C) are related to each other.

The upper coils (CF) are connected to each other via connection wirings (cL). The upper coils (CF) are connected to each other by connection wirings (cL) such that the circuit of FIG. 2B is formed. The first upper coil (CF11) and the first upper coil (CF21) are connected to each other in parallel via connection wirings (cL). The second upper coil (CF12) and the second upper coil (CF22) are connected to each other in parallel via connection wirings (cL). The third upper coil (CF13) and the third upper coil (CF23) are connected to each other in parallel via connection wirings (cL). The first parallel upper coil is connected to the second parallel upper coil via a connection wiring (cL). The second parallel upper coil is connected to the third parallel upper coil via a connection wiring (cL). The third parallel upper coil is connected to the first parallel upper coil via a connection wiring (cL). In FIG. 1C, the connection wirings (cL) are omitted. The connection wirings (cL) are partially drawn in FIG. 1C.

As illustrated in FIG. 1C, the coil substrate 201 of the first embodiment can have terminal substrates 24 and terminals (T) formed on the terminal substrates 24. The terminal substrates 24 and the flexible substrate 22 that supports the coils (C) are formed of a single-piece flexible substrate 22.

As illustrated in FIG. 1C, the coil substrate 201 of the first embodiment can include multiple terminal wirings (tL) that connect the connection wirings (cL) to the terminals (T).

The terminals (T) and the coils (C) are simultaneously formed. The number of the terminal substrates 24 is preferably half the number of the upper coils (CF). The number of the terminals (T) is preferably half the number of the upper coils (CF).

The single coils of Patent Document 1 are each formed of a wire. In contrast, the coils (C) of the embodiment are formed using a technology for a printed wiring board. Wirings (w) forming the coils (C) are formed by plating. Or, the wirings (w) forming the coils (C) are formed by etching a copper foil. The wirings (w) forming the coils (C) are formed using a semi-additive method, an M-Sap method, or a subtractive method.

The wirings (w) forming the coils (C) are formed using a technology for a printed wiring board. Therefore, a cross-sectional shape of each of the wirings (w) is substantially rectangular. Since a cross section of a wire is a circle, according to the embodiment, a space factor of the coils can be increased.

The coils (C) are each formed by a central space (SC) and a wiring (w) surrounding the central space (SC). The wiring (w) has an outer end (OE) and an inner end (IE). The wiring (w) is formed between the outer end (OE) and the inner end (IE). The wiring (w) forming a coil (C) is formed in a spiral shape.

By winding the coil substrate 201 in a tubular shape, the motor coil substrate 20 of the first embodiment is obtained. In this case, the coil substrate 201 is wound such that the portions (P) each form substantially one winding. Further, the j-th portion is wound on an outer side of the (j−1)-th portion.

An example of a method for winding the coil substrate 201 is described using FIG. 2A. When the coil substrate 201 of FIG. 1C is wound, as illustrated in FIG. 2A, the first portion (P1) forms substantially one winding. Further, the second portion (P2) connected to the first portion (P1) forms substantially one winding. In this case, the first portion (P1) is wound on the innermost side. The flexible substrate 22 forming the first portion (P1) is an inner peripheral flexible substrate (22I). Then, the second portion (P2) is wound on an outer side of the first portion (P1). The flexible substrate 22 forming the second portion (P2) forms an outer peripheral flexible substrate (22O). The outer peripheral flexible substrate (22O) extends from the inner peripheral flexible substrate (22I).

When K is 3, the coil substrate 201 is formed of the first portion (P1), the second portion (P2), and a third portion (P3). Then, the third portion (P3) connected to the second portion (P2) forms substantially one winding. Further, the third portion (P3) is wound on an outer side of the second portion (P2).

In the motor coil substrate 20, the m-th upper coil (CF) in the (j+1)-th portion is positioned on the m-th upper coil (CF) in the j-th portion. An example of this is illustrated in FIG. 2A. FIG. 2A is a cross-sectional view of the motor coil substrate 20 of the first embodiment. The first upper coil (CF21) in the second portion (P2) is positioned on the first upper coil (CF11) in the first portion (P1). The second upper coil (CF22) in the second portion (P2) is positioned on the second upper coil (CF12) in the first portion (P1). The third upper coil (CF23) in the second portion (P2) is positioned on the third upper coil (CF13) in the first portion (P1).

When the m-th upper coil (CF) in the (j+1)-th portion is positioned on the m-th upper coil (CF) in the j-th portion, the m-th upper coil (CF) in the j-th portion and the m-th upper coil (CF) in the (j+1)-th portion completely overlap each other. Or, the m-th upper coil (CF) in the j-th portion and the m-th upper coil (CF) in the (j+1)-th portion partially overlap each other.

In the motor coil substrate 20 of the embodiment, coils (C) connected to each other in parallel are arranged to overlap each other in the motor coil substrate 20. Therefore, multiple coils (C) can be efficiently connected to each other in parallel. Further, even when an output of the motor is increased, an amount of a current flowing in each of the coils can be reduced. Since a heat generation amount which is proportional to the square of the current can be reduced, efficiency of the motor coil substrate 20 can be increased.

### Second Embodiment

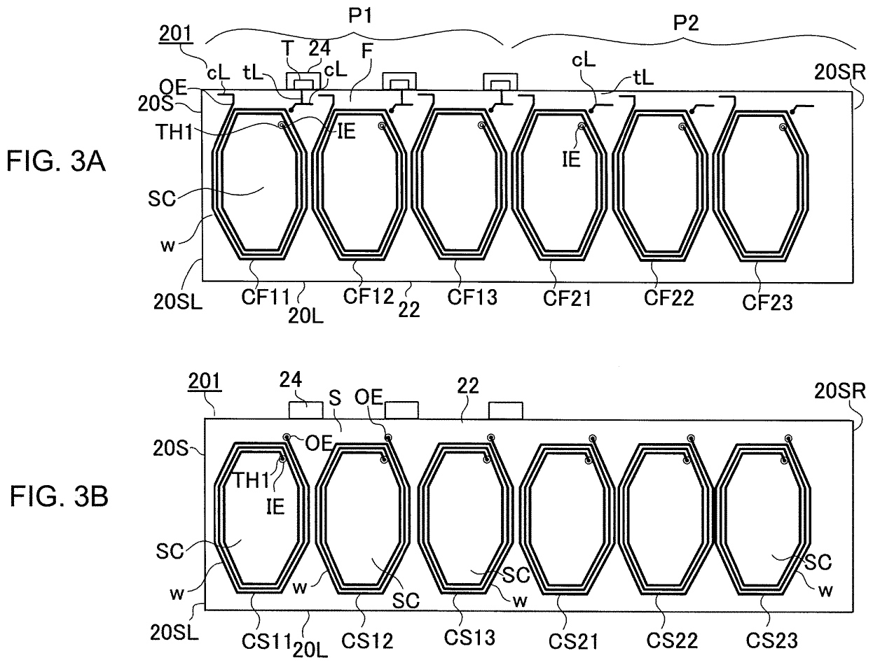

A coil substrate of a second embodiment has upper coils illustrated in FIG. 3A and lower coils illustrated in FIG. 3B. An upper coil and a lower coil are connected to each other by a through-hole conductor (TH 1) that connects to each other the inner ends (IE) of the wirings (w) that form the coils.

As illustrated in FIG. 2C, the m-th upper coil (CF) in the j-th portion and the m-th lower coil (CS) in the j-th portion are connected to each other in series. These coils form an m-th serial coil in the j-th portion. The m-th upper coil (CF) in the (j+1)-th portion and the m-th lower coil (CS) in the (j+1)-th portion are connected to each other in series. These coils form an m-th serial coil in the (j+1)-th portion. Then, the m-th serial coil in the j-th portion is connected in parallel to the m-th serial coil in the (j+1)-th portion. The m-th serial coil in the j-th portion and the m-th serial coil in the (j+1)-th portion, which are connected to each other in parallel, form an m-th parallel coil. As illustrated in FIG. 2C, the m-th parallel coil is connected in series to the (m+1)-th parallel coil.

As illustrated in FIG. 2C, the coil substrate 201 of the second embodiment can include connection wirings (cL) and terminal wirings (tL).

The m-th upper coil (CF) in the j-th portion and the m-th lower coil (CS) in the j-th portion are connected to each other by a connection wiring (cL). The m-th serial coil in the j-th portion and the m-th serial coil in the (j+1)-th portion are connected to each other by a connection wiring (cL). The m-th parallel coil and the (m+1)-th parallel coil are connected to each other by a connection wiring (cL).

A terminal wiring (tL it) connects a connection wiring (cL12) to a terminal (T), the connection wiring (cL12) connecting to each other the first parallel coil and the second parallel coil. A terminal wiring (tL2t) connects a connection wiring (cL23) to a terminal (T), the connection wiring (cL23) connecting to each other the second parallel coil and the third parallel coil. A terminal wiring (tL3t) connects a connection wiring (cL31) to a terminal (T), the connection wiring (cL31) connecting to each other the third parallel coil and the first parallel coil. A terminal wiring (tL) connects a connection wiring (cL) to a terminal (T), the connection wiring (cL) connecting to each other the m-th parallel coil and the (m+1)-th parallel coil.

In the example of FIG. 2C, the first upper coil (CF11) and the first lower coil (CS11) in the first portion (P1) are connected to each other in series. These coils form a first serial coil in the first portion (P1). Further, the first upper coil (CF21) and the first lower coil (CS21) in the second portion (P2) are connected to each other in series. These coils form a first serial coil in the second portion (P2). The first serial coil in the first portion (P1) and the first serial coil in the second portion (P2) are connected to each other in parallel via a connection wiring (cL1). The first serial coil in the first portion (P1) and the first serial coil in the second portion (P2) which are connected to each other in parallel form a first parallel coil.

The second upper coil (CF12) and the second lower coil (CS12) in the first portion (P1) are connected to each other in series. These coils form a second serial coil in the first portion (P1). Further, the second upper coil (CF22) and the second lower coil (CS22) in the second portion (P2) are connected to each other in series. These coils form a second serial coil in the second portion (P2). The second serial coil in the first portion (P1) and the second serial coil in the second portion (P2) are connected to each other in parallel via a connection wiring (cL2). The second serial coil in the first portion (P1) and the second serial coil in the second portion (P2) which are connected to each other in parallel form a second parallel coil.

The third upper coil (CF13) and the third lower coil (CS13) in the first portion (P1) are connected to each other in series. These coils form a third serial coil in the first portion (P1). Further, the third upper coil (CF23) and the third lower coil (CS23) in the second portion (P2) are connected to each other in series. These coils form a third serial coil in the second portion (P2). The third serial coil in the first portion (P1) and the third serial coil in the second portion (P2) are connected to each other in parallel via a connection wiring (cL3). The third serial coil in the first portion (P1) and the third serial coil in the second portion (P2) which are connected to each other in parallel form a third parallel coil.

The first parallel coil, the second parallel coil, and the third parallel coil are connected to each other in series. The first parallel coil and the second parallel coil are connected to each by the connection wiring (cL12). The second parallel coil and the third parallel coil are connected to each by the connection wiring (cL23). The third parallel coil and the first parallel coil are connected to each by the connection wiring (cL31). In the example of FIG. 2C, the third corresponds to the N-th.

Since the coils in the different portions are connected to each other in parallel, the multiple coils can be connected to each other with low resistance. A large current can be applied to the coils.

In the example of FIGS. 3A and 3B, K is 2. That is, the number of the portions (P) is 2. The coil substrate 201 of FIGS. 3A and 3B is formed of the first portion (P1) and the second portion (P2).

Further, L is 3. That is, the number of the upper coils (CF) in each of the portions (P) forming the coil substrate 201 of FIGS. 3A and 3B is 3. The first upper coil (CF11), the second upper coil (CF12), and the third upper coil (CF13) are arranged in the first portion (P1). The first upper coil (CF21), the second upper coil (CF22), and the third upper coil (CF23) are arranged in the second portion (P2).

The number of the lower coils (CS) in each of the portions (P) forming the coil substrate 201 illustrated in FIG. 3B is 3. The first lower coil (CS11), the second lower coil (CS12), and the third lower coil (CS13) are arranged in the first portion (P1). The first lower coil (CS21), the second lower coil (CS22), and the third lower coil (CS23) are arranged in the second portion (P2).

The electric motor of Japanese Patent Application Laid-Open Publication No. 2007-124892 includes multiple single coils formed of wires. The coils are formed of wires. When the wires are thin, it is thought that it is difficult to wind the wires. For example, it is thought that the wires may break. It is thought that it is difficult to wind the wires with high positional accuracy. In this case, a space factor may be decreased. For example, it is thought that a small electric motor can be manufactured by thinning the wires of Japanese Patent Application Laid-Open Publication No. 2007-124892. However, it is thought that it is difficult to apply a large current to the coils when the wires are thin.

A motor coil substrate according to an embodiment of the present invention is formed by winding a coil substrate that includes a flexible substrate and multiple coils, the flexible substrate having a one-end and an other-end on an opposite side with respect to the one-end, and the coils being formed on the flexible substrate and being arranged from the one-end toward the other-end. Then, the flexible substrate includes an inner peripheral flexible substrate and an outer peripheral flexible substrate that extends from the inner peripheral flexible substrate and is wound around the inner peripheral flexible substrate, the coils include coils (outer peripheral coils) formed on the outer peripheral flexible substrate and coils (inner peripheral coils) formed on the inner peripheral flexible substrate, the number of the outer peripheral coils and the number of the inner peripheral coils are each L, the m-th outer peripheral coil is positioned on the m-th inner peripheral coil, and the m-th outer peripheral coil and the m-th inner peripheral coil are connected to each other in parallel, wherein L and m are natural numbers.

According to an embodiment of the present invention, coils are formed of wirings. For example, the coils can be formed using a technology for a printed wiring board. Therefore, the wirings forming the coils can be formed to each have a substantially rectangular cross-sectional shape. A space factor of the coils can be increased. The motor coil substrate of the embodiment has coils connected to each other in parallel. Even when the motor coil substrate has multiple coils, the coils can be connected with low resistance. A large current can be applied to the coils forming the motor coil substrate. A motor having high efficiency can be provided.

Obviously, numerous modifications and variations of the present invention are possible in light of the above teachings. It is therefore to be understood that within the scope of the appended claims, the invention may be practiced otherwise than as specifically described herein.

What is claimed is:

1. A motor coil substrate, comprising:
a coil substrate comprising a flexible substrate and a plurality of coils formed on the flexible substrate such that the plurality of coils is extending from a first end of the flexible substrate toward a second end of the flexible substrate on an opposite side with respect to the first end,
wherein the flexible substrate includes an inner peripheral flexible substrate and an outer peripheral flexible substrate extending from the inner peripheral flexible substrate and wound around the inner peripheral flexible substrate such that the plurality of coils includes a plurality of outer peripheral coils formed on the outer peripheral flexible substrate and a plurality of inner peripheral coils formed on the inner peripheral flexible substrate, that of a number of the outer peripheral coils and a number of the inner peripheral coils are L, that an m-th outer peripheral coil of the outer peripheral coils is positioned on a m-th inner peripheral coil of the inner peripheral coils, and that the m-th outer peripheral coil and the m-th inner peripheral coil are connected to each other in parallel, where L and m are natural numbers.

2. The motor coil substrate according to claim 1, wherein the plurality of coils is formed such that a (m+1)-th outer peripheral coil of the outer peripheral coils and a (m+1)-th inner peripheral coil of the inner peripheral coils are connected to each other in parallel, that the m-th outer peripheral coil and the m-th inner peripheral coil form an m-th parallel coil, that the (m+1)-th outer peripheral coil and the (m+1)-th inner peripheral coil form an (m+1)-th parallel coil, and that the m-th parallel coil is connected in series to the (m+1)-th parallel coil.

3. The motor coil substrate according to claim 1, wherein the plurality of coils includes a plurality of upper coils formed on a first surface of the flexible substrate, and a plurality of lower coils formed on a second surface of the flexible substrate on an opposite side with respect to the first surface, and the coil substrate includes a plurality of through-hole conductors penetrating through the flexible substrate and formed such that an upper coil of the upper coils and a lower coil of the lower coils facing each other via the flexible substrate are connected to each other by a respective one of the through-hole conductors.

4. The motor coil substrate according to claim 3, wherein the plurality of coils is formed such that each of the upper coils and the lower coils comprises a central space and a wiring surrounding the central space in a spiral shape and having an outer end, and an inner end connected to the respective one of the through-hole conductors.

5. A motor, comprising:
the motor coil substrate of claim 1; and
a magnet positioned inside the motor coil substrate.

6. The motor coil substrate according to claim 2, wherein the plurality of coils includes a plurality of upper coils formed on a first surface of the flexible substrate, and a plurality of lower coils formed on a second surface of the flexible substrate on an opposite side with respect to the first surface, and the coil substrate includes a plurality of through-hole conductors penetrating through the flexible substrate and formed such that an upper coil of the upper coils and a lower coil of the lower coils facing each other via the flexible substrate are connected to each other by a respective one of the through-hole conductors.

7. The motor coil substrate according to claim 6, wherein the plurality of coils is formed such that each of the upper coils and the lower coils comprises a central space and a wiring surrounding the central space in a spiral shape and having an outer end and an inner end connected to the respective one of the through-hole conductors.

8. A motor, comprising:
the motor coil substrate of claim 2; and
a magnet positioned inside the motor coil substrate.

9. A motor, comprising:
the motor coil substrate of claim 3; and
a magnet positioned inside the motor coil substrate.

10. A motor, comprising:
the motor coil substrate of claim 4; and
a magnet positioned inside the motor coil substrate.

11. A motor, comprising:
the motor coil substrate of claim 6; and
a magnet positioned inside the motor coil substrate.

12. A motor, comprising:
the motor coil substrate of claim 7; and
a magnet positioned inside the motor coil substrate.

13. The motor coil substrate according to claim 1, wherein the plurality of coils includes a plurality of upper coils formed on a first surface of the flexible substrate, and a plurality of lower coils formed on a second surface of the flexible substrate on an opposite side with respect to the first surface.

14. The motor coil substrate according to claim 1, wherein each of the coils comprises a central space and a wiring surrounding the central space in a spiral shape and having an outer end and inner end.

15. The motor coil substrate according to claim 2, wherein each of the coils comprises a central space and a wiring surrounding the central space in a spiral shape and having an outer end and inner end.

16. The motor coil substrate according to claim 13, wherein each of the coils comprises a central space and a wiring surrounding the central space in a spiral shape and having an outer end and inner end.

17. A motor, comprising:
the motor coil substrate of claim 13; and
a magnet positioned inside the motor coil substrate.

18. A motor, comprising:
the motor coil substrate of claim 14; and
a magnet positioned inside the motor coil substrate.

19. A motor, comprising:
the motor coil substrate of claim 15; and
a magnet positioned inside the motor coil substrate.

20. A motor, comprising:
the motor coil substrate of claim 16; and
a magnet positioned inside the motor coil substrate.
